(19) United States
(12) Patent Application Publication
(10) Pub. No.: US 2022/0120876 A1
(43) Pub. Date: Apr. 21, 2022

(54) RECEIVER DEVICE FOR LIDAR AND LIDAR

(71) Applicant: VisionICs Microelectronics Technology Co.,Ltd., Nanjing (CN)

(72) Inventors: Kunzhi Yu, Nanjing (CN); Cheng Li, Nanjing (CN); Xiaolin Huang, Nanjing (CN)

(73) Assignee: VisionICs Microelectronics Technology Co.,Ltd., Nanjing (CN)

(21) Appl. No.: 17/427,662

(22) PCT Filed: Jun. 26, 2019
(86) PCT No.: PCT/CN2019/092998

§ 371 Date: Aug. 2, 2021

(30) Foreign Application Priority Data
May 29, 2019 (CN) 201910455266.8

(51) Int. Cl. G01S 7/4865; G01S 7/481

(52) U.S. Cl. CPC G01S 7/4865; G01S 7/4816

(57) ABSTRACT

A lidar device (100), including: a transmitter module (120), a receiver monolithic module (150), and a coordination circuit module (110) connected to the transmitter module (120) and the receiver monolithic module (150), wherein components of the transmitter module (120), the receiver monolithic module (150) and the coordination circuit module (110) are all solid-state electronic components or micro-electro-mechanical components.

### TECHNICAL FIELD

The present invention relates to a lidar, and particularly to a receiver device for lidar.

### BACKGROUND

Lidar is a non-contact active optical ranging system, which can measure information, such as distance, size and intensity of a target object in space stably and reliably. In the fields of unmanned vehicle and robot 3D vision, lidar can provide high-resolution point cloud data and 3D scene reconstruction functions, and will not be affected by external factors, such as day and night, temperature, environment, weather, etc.

The design of traditional lidar systems, especially a receiver, requires the use of multiple chips. These chips work together in a receiving end system to realize the 3D ranging function of an object. The design of multi-chip lidar receivers is complicated, costly, bulky, and less reliable.

Therefore, it is necessary to design a receiver specifically used in a lidar. Lidar receiver system chip design with high integration can greatly reduce the complexity and cost of system development, and provide a reliable solution for miniaturization and mass production of lidar systems.

### SUMMARY OF THE INVENTION

The object of the present invention is to provide a receiver device for lidar, which reduces the development difficulty and system cost of the lidar receiving end system, and provides system integration to realize the miniaturization of the system.

In order to achieve the above objects, the following technical solution is adopted according to the present invention: a receiver device for lidar, chip design of which integrates: (1) a photodetector array module, each photodetector comprising a single photon detector, a quench and reset circuit, a coherent decision circuit, and a readout circuit; (2) a clock signal module, comprising time-to-digital conversion modules, a clock signal generation module, and a clock signal distribution module; (3) a receiver control module, comprising a storage module, a processing module, a timing control module, and an interface module.

According to a technical solution of the invention, there is provided a receiver device for lidar, comprising: a photodetector array module for receiving a laser echo, wherein the photodetector array module comprises a plurality of photodetectors, each generating a trigger signal according to the received laser echo; a clock signal module connected to the photodetector array module and comprising a plurality of time-to-digital converters, each receiving a start signal representing laser emission, the trigger signal from the photodetector as a termination signal, and a high-speed clock signal, calculating time difference between the termination signal and the start signal using the high-speed clock signal as a reference, and then generating a time difference digital signal; as well as a receiver control module connected to the clock signal module, comprising: a timing control module for generating the start signal; a storage module for receiving the time difference digital signals output from the plurality of time-to-digital converters, and storing them as corresponding time difference values; a processing module connected to the timing control module and the storage module, for generating multiple pieces of distance information according to the multiple time difference values after receiving an instruction from the timing control module; and an interface module connected to the processing module, for transmitting the multiple pieces of distance information out, wherein the receiver device is provided in a single package.

In the technical solution, in order to provide a high-reliability, low-cost, and miniaturized receiver solution, the above-mentioned receiver device is provided on a single chip.

In the technical solution, in order to simplify the design of the time-to-digital converters, the trigger signal is a voltage digital signal.

In the technical solution, in order to improve the detection speed and performance of the lidar, the above-mentioned photodetector comprises: a single photon detector for receiving the laser echo to generate the trigger signal; a quench and reset circuit connected to the single photon detector, for resetting the single photon detector to wait for the next trigger after generating the trigger signal; and a readout circuit for transmitting the trigger signal to the corresponding time-to-digital converter.

In the technical solution, in order to reduce noise interference, the above-mentioned photodetector further comprises: a coherent decision circuit connected to the single photon detector, for determining whether the trigger signal is triggered by noise after the generation of it, and transmitting the trigger signal to the readout circuit when the trigger signal is not triggered by noise.

In the technical solution, in order to improve the accuracy of detection, the above-mentioned clock signal module further comprises: a clock signal generation module for generating a plurality of high-speed clock signals, wherein each of the plurality of high-speed clock signals has a different phase but the same frequency; and a clock signal distribution module connected to the clock signal generation module, for distributing the plurality of high-speed clock signals to the plurality of time-to-digital converters.

In the technical solution, in order to lower the cost of the time-to-digital converters, the number of the plurality of photodetectors is greater than or equal to the number of the plurality of time-to-digital converters.

In the technical solution, in order to generate point cloud data and/or 3D spatial data, the process module further comprises a digital signal processor for executing a processing module which is used to generate the multiple pieces of distance information according to the multiple time difference values after receiving the instruction from the timing control module.

In the technical solution, in order to improve the accuracy of detection, the start signal is further transmitted to a transmitter device for lidar to control the transmitter device to emit laser light.

According to a technical solution of the invention, there is provided a lidar, comprising: the above-mentioned receiver device; a transmitter device connected to the receiver device, for emitting laser light according to start signal transmitted by the receiver device; and a control device connected to the receiver device, for receiving multiple pieces of distance information.

The beneficial effects of the invention include: (1) each photodetector utilizes a single photon detector, which has the characteristics of high integration and high sensitivity, which improves the pixel resolution and measuring distance of the lidar system; (2) each photodetector utilizes a coherent decision circuit to remove device noise, background light noise and other noise interference; (3) the highly integrated lidar receiver system chip integrates all the detector chip, analog circuit chip, time-to-digital converter chip, digital signal processing chip, and interface communication chip into one chip, thereby providing a high-reliability, low-cost, and miniaturized receiver solution for the design of lidar systems.

### BRIEF DESCRIPTION OF THE DRAWINGS

FIG. 1 is a block diagram of a lidar according to an embodiment of the present invention.

FIG. 2 is a block diagram of the receiver device provided by the present invention.

FIG. 3 is a block diagram of the photodetector provided by the present invention.

### DETAILED DESCRIPTION OF THE INVENTION

Some embodiments of the present invention will be described in detail as follows. However, the scope of the present invention is not limited by the disclosed embodiments, but is subject to the claims. In order to provide a clearer description and to enable those of ordinary skill in the art to better understand the content of the present invention, the parts in the figure are not drawn to scale. The proportions of certain sizes or other related scales may be highlighted and thus exaggerated, and the irrelevant details are not fully drawn, for the sake of simplicity.

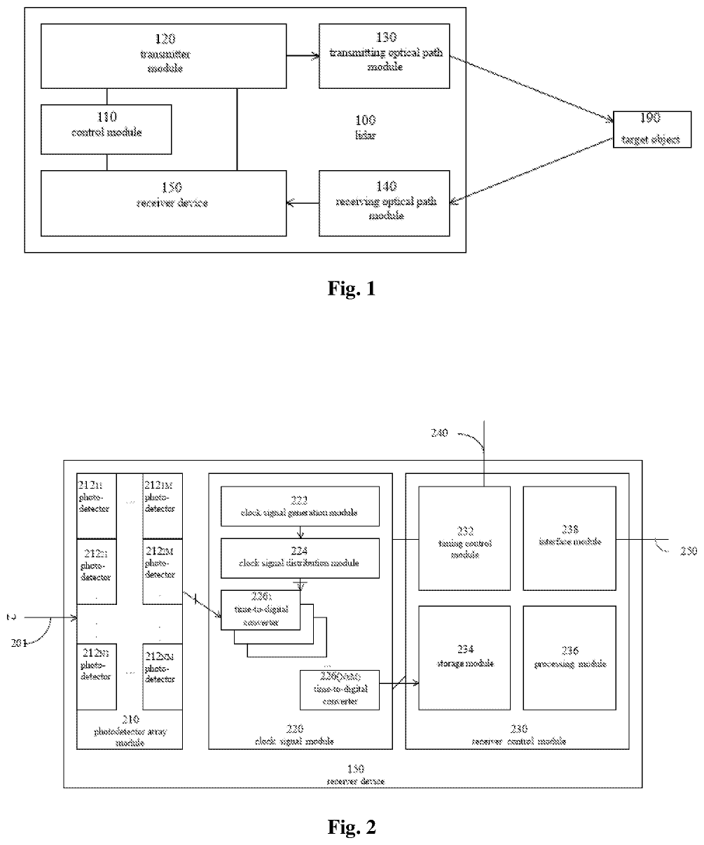

Referring to FIG. 1, it is a block diagram of a lidar 100 according to an embodiment of the present invention. The lidar 100 comprises the following modules: a control module 110 for controlling the entire lidar 100, a transmitter module 120 for generating laser light, a transmitting optical path module 130 for transmitting laser light outside the lidar 100, a receiving optical path module 140 for receiving a laser echo reflected from a target object 190, and a receiver device 150.

The aforementioned control module 110 has an external interface, which can be used to receive external instructions to accordingly turn on and off the lidar 100, as well as other control instructions. The control module 110 controls the transmitter module 120 and the receiver device 150 to perform corresponding tasks after receiving an instruction. In addition, the control module 110 can return the target information received and interpreted by the receiver device 150, such as distance information and intensity information about the target object, to the outside world. In some embodiments, the control module 110 may comprise a specific logic circuit and/or microprocessor, and the programs it executes can perform advanced functions such as the identification and tracking of one or more target objects 190, and the control of the frequency/amplitude/phase modulation and demodulation of the laser signal, according to the above-mentioned target information.

The difference between the time when the laser light is emitted from the transmitter module 120 and the time when it is detected by the receiver device 150 is the basis for measuring the distance of the target object 190. Therefore, the transmitter module 120 and the receiver device 150 must cooperate closely. In an embodiment of the present invention, the receiver device 150 sends a signal to the transmitter module 120, so that the transmission and reception processing circuits of the two can be synchronized in time. In the following paragraphs, the implementation of synchronization between the two ones will be mentioned.

As mentioned in the Background section, as the size and weight of the lidar 100 become smaller and smaller, the integration of each module must be higher to meet the demand for more portability. For the receiver device 150, integrating necessary components into a single chip can meet the requirements of high reliability, low cost, and miniaturization.

Referring to FIG. 2, it is a block diagram of the receiver device 150 for lidar provided by the present invention. In an embodiment, the receiver device 150 is designed as a single chip, and all logic circuits are integrated in a single chip. In another embodiment, the receiver device 150 is designed as a single package, wherein a plurality of chips interconnected with each other are contained in a single package. These chips can be placed on one or more interposers and/or substrates, and the interconnecting circuits thereof are fabricated through multilayer interposer and/or substrate windings.

The receiver device 150 comprises the following three modules: a photodetector array module 210, a clock signal module 220 and a receiver control module 230. For example, in order to reduce the area of the package or facilitate the design of the receiving optical path module 140, the photodetector array module 210 can be fabricated on a chip and placed on one side of an interposer or substrate, while the rest, the clock signal module 220 and the receiver control module 230 can be placed on the other side of the interposer or substrate.

The photodetector array module 210 includes a one-dimensional or two-dimensional array, and comprises a plurality of photodetectors 212. In the embodiment shown in FIG. 2, there are a total of N×M photodetectors 212₁₁ to 212_{NM}. Under normal working conditions, laser light is emitted by the transmitter module 120 to the target object 190, and a reflected echo 201 is generated. The photodetector array module 210 is responsible for receiving the reflected echo 201, and converting the received laser light into an electrical signal, such as a current signal or a voltage signal.

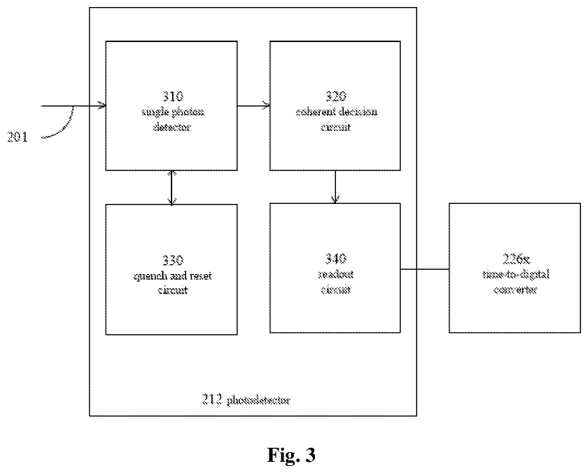

Referring to FIG. 3, it is a block diagram of the photodetector 212 provided by the present invention. In the embodiment, each of the photodetectors 212 comprises the following four modules: a single photon detector 310, a coherent decision circuit 320 connected to the single photon detector 310, a quench and reset circuit 330 connected to the single photon detector 310, and a readout circuit 340 connected to the coherent decision circuit 320. The readout circuit 340 is also connected to the clock signal module 220.

When the single photon detector 310 is hit by photons of the reflected echo 201, it can count the detected photons and generate a trigger signal. The trigger signal is sent to the coherent decision circuit 320 and the quench and reset circuit 330 respectively. The quench and reset circuit 330 resets the single photon detector 310 to wait for the next photon trigger. The coherent decision circuit 320 is used to determine whether the trigger signal is triggered by noise or a real laser signal. No signal is output to the readout circuit 340 if it is triggered by noise. The coherent decision circuit 320 will instruct the readout circuit 340 to output a voltage signal corresponding to the trigger to the clock signal module 220 when it is determined that the signal is triggered by a real laser signal. In an embodiment, the voltage signal may be a digital signal.

In an embodiment, the coherent decision circuit 320, the quench and reset circuit 330, and the readout circuit 340 may not form an element along with the single photon detector 310. single photon detector 310, coherent decision circuit 320, quench and reset circuit 330, and readout circuit 340 can each be integrated into a small module; a sub-array is formed with these four small modules; and then multiple such sub-arrays are integrated into a complete array. That is, in some applications, the sub-arrays can be formed first, and then the complete photodetector array module 210 can be formed. The way of forming the photodetector array module 210 is flexible.

In an embodiment, the coherent decision circuit 320 is optional. That is, the readout circuit can send out the trigger signal directly without considering whether it is triggered by noise.

Referring back to FIG. 2, the clock signal module 220 comprises a clock signal generation module 222 for generating multi-phase high-speed clock signals. The clock signal generation module 222 may contain an oscillator as a signal source of clock signal, and may also receive a clock signal generated by an oscillator included in other modules in the lidar 100 as a signal source. Because the circuit lengths between a plurality of readout circuits 340 contained in the photodetector array module 210, and the clock signal module 220 are different, and because the frequency of generating trigger signals is high, multiple high-speed clock signals of different phases are generated by the clock signal generation module 222 using clock signals of the signal source, and distributed to each time-to-digital converter 226, through the circuits contained in the clock signal distribution module 224. Accordingly, clock signals of different phases can be used to solve the problems as phase jitter, distortion, and offset caused by different circuit lengths.

The time-to-digital converter 226 is used to receive the high-speed clock signal from the clock signal distribution module 224, the voltage signal output by the readout circuit 340, and the start signal from the receiver control module 230 indicating the laser emission time. Using the high-speed clock signal as a reference, the time-to-digital converter 226 can calculate the time difference between the start signal and the voltage signal as the termination signal. The time difference can be expressed as a time difference digital signal that reflects the echo time information. The time-to-digital converter 226 transmits the time difference digital signal to the receiver control module 230.

In one embodiment, the number of the time-to-digital converters 226 is equivalent to the number of the photodetectors 212, the ratio between them is 1:1. For example, since there are N×M photodetectors 212 in the embodiment of FIG. 2, there are N×M time-to-digital converters 226 too. In another embodiment, in order to reduce the cost of the time-to-digital converters 226, a time-to-digital converter 226 may be time-division multiplexed by multiple photodetectors 212, that is, the number of the plurality of photodetectors 212 can be greater than or equal to the number of the plurality of time-to-digital converters 226.

In one embodiment, each of high-speed clock signals received by the plurality of time-to-digital converters 226 may have different phases. However, in another embodiment, high-speed clock signals of the same phase can be supplied to two or more time-to-digital converters 226. In other words, the relationship between the number of phases of the high-speed clock signals and the number of the time-to-digital converters 226 is not limited in the present invention.

The receiver control module 230 comprises the following four modules: a timing control module 232, a storage module 234, a processing module 236 and an interface module 238. The timing control module 232 is used to generate the above-mentioned start signal and a control signal 240 instructing the transmitter module 120 to emit laser light. The storage module 234 is used to store multiple time difference values corresponding to the multiple time difference digital signals output from each time-to-digital converter 226 respectively.

The multiple time difference values stored by the storage module 234 can be emptied after the control signal 240 is generated by the timing control module 232. The timing control module 232 will send a signal to instruct the processing module 236 to process the multiple time difference values after generating the control signal 240 for a period of time.

The processing module 236 may contain a digital signal processor, or may contain a specific logic circuit design for performing the following tasks. The instruction or logic circuit executed by the digital signal processor can convert the multiple time difference values into multiple pieces of distance information, when receiving the signal notification from the timing control module 232. Then, according to the arranging order of the photodetectors 212 of the photodetector array module 210, the interface module 238 outputs the multiple pieces of distance information 250 to the control module 110. The control module 110 can further generate point cloud data and/or 3D scenes according to the distance information 250.

In another embodiment, the distance information can be output to other master computers or control systems.

The aforementioned interface between the timing control module 232 and the transmitter module 120 may be an exclusive specific interface or a standard industrial interface, such as I²C, USB, PCI, PCI-Express, etc., as long as the delay time of its specification can meet the time delay of laser emission in the present invention.

The aforementioned interface between the interface module 238 and the outside world may be an exclusive specific interface or a standard industrial interface, such as I²C, USB, PCI, PCI-Express, etc., as long as the transmission rate of its specification can meet the transmission distance information and/or intensity information 250 in the present invention.

According to an embodiment of the present invention, there is provided a receiver device for lidar, comprising: a photodetector array module for receiving a laser echo, wherein the photodetector array module comprises a plurality of photodetectors, each generating a trigger signal according to the received laser echo; a clock signal module connected to the photodetector array module and comprising a plurality of time-to-digital converters, each receiving a start signal representing laser emission, the trigger signal from the photodetector as a termination signal, and a high-speed clock signal, calculating time difference between the termination signal and the start signal using the high-speed clock signal as a reference, and then generating a time difference digital signal; as well as a receiver control module connected to the clock signal module, comprising: a timing control module for generating the start signal; a storage module for receiving the time difference digital signals output from the plurality of time-to-digital converters, and storing them as corresponding time difference values; a processing module connected to the timing control module and the storage module, for generating multiple pieces of distance information according to the multiple time difference values after receiving an instruction from the timing control module; and an interface module connected to the processing module, for transmitting the multiple pieces of distance information out, wherein the receiver device is provided in a single package.

In the embodiment, in order to provide a high-reliability, low-cost, and miniaturized receiver solution, the above-mentioned receiver device is provided on a single chip.

In the embodiment, in order to simplify the design of the time-to-digital converters, the trigger signal is a voltage digital signal.

In the embodiment, in order to improve the detection speed and performance of the lidar, the above-mentioned photodetector comprises: a single photon detector for receiving the laser echo to generate the trigger signal; a quench and reset circuit connected to the single photon detector, for resetting the single photon detector to wait for the next trigger after generating the trigger signal; and a readout circuit for transmitting the trigger signal to the corresponding time-to-digital converter.

In the embodiment, in order to reduce noise interference, the above-mentioned photodetector further comprises: a coherent decision circuit connected to the single photon detector, for determining whether the trigger signal is triggered by noise after the generation of it, and transmitting the trigger signal to the readout circuit when the trigger signal is not triggered by noise.

In the embodiment, in order to improve the accuracy of detection, the above-mentioned clock signal module further comprises: a clock signal generation module for generating a plurality of high-speed clock signals, wherein each of the plurality of high-speed clock signals has a different phase but the same frequency; and a clock signal distribution module connected to the clock signal generation module, for distributing the plurality of high-speed clock signals to the plurality of time-to-digital converters.

In the embodiment, in order to generate point cloud data and/or 3D spatial data, the process module further comprises a digital signal processor for executing an algorithm module which is used to generate the multiple pieces of distance information according to the multiple time difference values after receiving the instruction from the timing control module.

In the embodiment, in order to improve the accuracy of detection, the start signal is further transmitted to a transmitter device for lidar to control the transmitter device to emit laser light.

According to an embodiment of the present invention, there is provided a lidar, comprising: the above-mentioned receiver device; a transmitter device connected to the receiver device, for emitting laser light according to start signal transmitted by the receiver device; and a control device connected to the receiver device, for receiving multiple pieces of distance information.

The above are only the preferred embodiments of the present invention, and do not limit the present invention in any form. Although the present invention has been disclosed in the preferred embodiments as above, it is not intended to limit the present invention. Any person skilled in the art, without departing from the scope of the claims of the present invention, should be able to use the technical content disclosed above to make equivalent embodiments, with some variations or modifications being equivalent changes. Without departing from the scope of the claims of the present invention, any simple variations, equivalent changes and modifications made to the above embodiments based on the technical essence of the present invention fall within the content of the claims of the present invention.

1. A receiver device for lidar, characterized in that, it comprises:
a photodetector array module for receiving a laser echo, wherein the photodetector array module comprises a plurality of photodetectors, each generating a trigger signal according to the received laser echo;
a clock signal module connected to the photodetector array module and comprising a plurality of time-to-digital converters, each receiving a start signal representing laser emission, the trigger signal from the photodetector as a termination signal, and a high-speed clock signal, calculating time difference between the termination signal and the start signal using the high-speed clock signal as a reference, and then generating a time difference digital signal; as well as
a receiver control module connected to the clock signal module, comprising:
a timing control module for generating the start signal;
a storage module for receiving the time difference digital signals output from the plurality of time-to-digital converters, and storing them as corresponding time difference values;
a processing module connected to the timing control module and the storage module, for generating multiple pieces of distance information according to the multiple time difference values after receiving an instruction from the timing control module; and
an interface module connected to the processing module, for transmitting the multiple pieces of distance information out,
wherein the receiver device is provided in a single package.

2. The receiver device for lidar of claim 1, characterized in that, the receiver device is provided on a single chip.

3. The receiver device for lidar of claim 1, characterized in that, the trigger signal is a voltage digital signal.

4. The receiver device for lidar of claim 1, characterized in that, the photodetector comprises:
a single photon detector for receiving the laser echo to generate the trigger signal;
a quench and reset circuit connected to the single photon detector, for resetting the single photon detector to wait for the next trigger after generating the trigger signal; and
a readout circuit for transmitting the trigger signal to the corresponding time-to-digital converter.

5. The receiver device for lidar of claim 4, characterized in that, the photodetector further comprises:
a coherent decision circuit connected to the single photon detector, for determining whether the trigger signal is triggered by noise after the generation of it, and transmitting the trigger signal to the readout circuit when the trigger signal is not triggered by noise.

6. The receiver device for lidar of claim 1, characterized in that, the clock signal module further comprises:
a clock signal generation module for generating a plurality of high-speed clock signals, wherein each of the plurality of high-speed clock signals has a different phase but the same frequency; and
a clock signal distribution module connected to the clock signal generation module, for distributing the plurality of high-speed clock signals to the plurality of time-to-digital converters.

7. The receiver device for lidar of claim 1, characterized in that, the number of the plurality of photodetectors is greater than or equal to the number of the plurality of time-to-digital converters.

8. The receiver device for lidar of claim 1, characterized in that, the process module further comprises a digital signal processor for executing an algorithm module which is used to generate the multiple pieces of distance information according to the multiple time difference values after receiving the instruction from the timing control module.

9. The receiver device for lidar of claim 1, characterized in that, the start signal is further transmitted to a transmitter device for lidar to control the transmitter device to emit laser light.

10. A lidar, characterized in that, it comprises:
the receiver device for lidar of claim 1;
a transmitter device connected to the receiver device, for emitting laser light according to start signal transmitted by the receiver device; and
a control device connected to the receiver device, for receiving multiple pieces of distance information.
